(19) United States
(12) Patent Application Publication
(10) Pub. No.: US 2007/0086301 A1
(43) Pub. Date: Apr. 19, 2007

(54) DISK EVALUATING DEVICE AND DISK EVALUATING METHOD

(75) Inventor: Hideyuki YAMAKAWA, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/548,536

(22) Filed: Oct. 11, 2006

(30) Foreign Application Priority Data
Oct. 19, 2005 (JP) 2005-304435

(51) Int. Cl. G11B 20/10

(52) U.S. Cl. 369/59.22

(57) ABSTRACT

A disk evaluating device includes a PR equalizer that equalizes reproduced signals from a disk to a response waveform of a partial response of a predetermined class, a maximum likelihood detector that performs maximum likelihood decoding on output signals from the PR equalizer, and an evaluating unit that classifies binary data output from the maximum likelihood detector into bit patterns of strings of consecutive bits, each of the strings having a predetermined length, and obtaines a histogram of amplitudes of the output signals from the PR equalizer for each of the bit patterns.

### CROSS-REFERENCE TO RELATED APPLICATIONS

This application claims the benefit of priority of Japanese Patent Application No. 2005-304435, filed Oct. 19, 2005, the entire contents of which are incorporated herein by reference.

### BACKGROUND

1. Field

The present invention relates to disk evaluating devices and disk evaluating methods, and in particular, relates to a disk evaluating device and a disk evaluating method for evaluating and checking disks, for example, DVDs.

2. Description of the Related Art

In recording media such as DVDs, it is ideal that written data completely coincides with read data. However, in practice, written data may not coincide with read data due to various types of factor. That is to say, it is difficult to completely eliminate bit errors, and there is no other choice but to accept a certain frequency of occurrence of bit errors.

Factors that cause bit errors include factors arising from recording and playback systems, such as recording devices and playback devices, and factors arising from failures in manufacturing disks and variations in quality of individual disks.

Disk evaluating devices are mainly used to test and evaluate disks to assure that the level of the quality of the disks is equal to or more than a predetermined level. For example, a disk evaluating device eliminates disks of quality equal to or less than a predetermined standard value by directly or indirectly measuring the bit error rate to assure the quality of disks that are distributed to the market.

Disks such as DVDs are mass-produced. Simultaneously, the manufacturing costs of the disks need to be reduced. Thus, a disk evaluating device and a disk evaluating method are needed, in which individual disks can be tested and evaluated in a short time.

On the other hand, in general, the bit error rate takes on a very small value, for example, 10⁻⁵. Thus, when a method is adopted, in which the bit error rate is directly measured by comparing input (recorded data) with output (reproduced data), a large number of data samples are necessary to achieve highly reliable measurement result, and thus the measurement requires long time.

Accordingly, hitherto, techniques have been proposed, for shortening test time by testing disks using, for example, intermediate signals of reproduced signals from the disks instead of a method for directly measuring the bit error rate of the final output.

For example, techniques are disclosed in JP-A 2003-203429 and JP-A 2003-187534, which are related to disk evaluating devices that can create a histogram of signals output from an equalizer and a histogram of difference metric values and evaluate the quality of disks on the basis of the distribution of these histograms.

In disks such as DVDs, a signal processing technique called PRML (Partial Response Maximum Likelihood) is adopted to increase the recording density. A recording and playback system in which PRML signal processing is adopted has PR characteristics that intentionally create intersymbol interference. In PR characteristics, reproduced signals of disks are not binary signals corresponding to 0 or 1 but multilevel signals corresponding to past bit patterns of bit strings each having a predetermined length. Bit strings are reproduced by obtaining the most likely bit pattern by the maximum likelihood method from the multilevel signals.

A filter called PR equalizer is provided in a playback circuit to bring reproduced signals close to ideal PR characteristics. In JP-A 2003-203429, signals output from a PR equalizer are obtained and stored, and the frequency for each output level is obtained to create a histogram.

Viterbi decoding may be used as a specific method for obtaining (estimating) bit patterns by the maximum likelihood method (Since Viterbi decoding is a known art and described in, for example, Japanese Unexamined Patent Application Publication No. 2003-203429, the description of the details is omitted here). In Viterbi decoding, one index that represents the likelihood of estimation of a bit pattern is an index called difference metric value or SAM (Sequenced Amplitude Margin). The likelihood of the estimation increases as the difference metric value (or the SAM) increases, and the likelihood of the estimation decreases as the difference metric value (or the SAM) decreases. There is a strong correlation between the difference metric value (or the SAM) and the bit error rate. Thus, the bit error rate can be indirectly evaluated by evaluating the difference metric value (or the SAM).

Techniques are disclosed in JP-A 2003-203429 and JP-A 2003-187534, for extracting difference metric values as intermediate signals of reproduced signals of disks and creating a histogram.

In general, in devices that evaluate and test products, it is often the case that a function of providing data for finding a cause when a product does not satisfy the evaluation criteria is needed in addition to a function of checking the quality of the product. Even in the case of a mass-produced product, the product is not always manufactured with constant quality, and a defective product may frequently occur suddenly from a certain point in time. In this case, detailed micro data, not macro data, is necessary to find a cause of a deterioration in quality.

The output from a PR equalizer has multiple values corresponding to individual bit patterns, as described above. In an ideal case where there is no error, these values must be equal to specific values. However, in practice, these values vary with respect to specific ideal values with errors due to various types of error factor. From a microscopic viewpoint, the type and amount of an error vary with the past bit pattern of the corresponding bit string having a predetermined length (for example, three or five bits).

In the techniques shown in JP-A 2003-203429 and JP-A 2003-187534, intermediate signals, such as signals output from PR equalizers and difference metric values, are extracted from reproduced signals of disks and statistically processed to create a histogram. That is to say, data that includes all bit patterns is statistically processed at the macro level regardless of types of bit pattern.

Thus, although these techniques are usable in a test device that comprehensively checks the quality in a short time, data sufficient to analyze error factors that vary with individual bit patterns cannot be provided.

### SUMMARY OF THE INVENTION

In view of the foregoing problems, it is an object of the present invention to provide a disk evaluating device and a disk evaluating method in which, in a case where disks such as DVDs are tested and evaluated, when the quality of the disks does not satisfy a standard value, highly accurate data for finding the causes can be readily obtained.

To solve the foregoing problems, a disk evaluating device according to an aspect of the present invention includes a PR equalizer that equalizes reproduced signals from a disk to a response waveform of a partial response of a predetermined class, a maximum likelihood detector that performs maximum likelihood decoding on output signals from the PR equalizer, and an evaluating unit that classifies binary data output from the maximum likelihood detector into bit patterns of strings of consecutive bits, each of the strings having a predetermined length, and obtains a histogram of amplitudes of the output signals from the PR equalizer for each of the bit patterns.

Moreover, to solve the foregoing problems, a disk evaluating method according to another aspect of the present invention includes a PR equalizing step of equalizing reproduced signals from a disk to a response waveform of a partial response of a predetermined class, a maximum likelihood decoding step of performing maximum likelihood decoding on output signals from the PR equalizing step, and an evaluating step of classifying binary data obtained in the maximum likelihood decoding step into bit patterns of strings of consecutive bits, each of the strings having a predetermined length, and obtaining a histogram of amplitudes of the signals equalized in the PR equalizing step for each of the bit patterns.

In the disk evaluating device and the disk evaluating method according to the present invention, in a case where disks such as DVDs are tested and evaluated, when the quality of the disks does not satisfy a standard value, highly accurate data for finding the causes can be readily obtained.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing a typical structure of a disk evaluating device according to an embodiment of the present invention;

FIGS. 2A and 2B are illustrations showing the concept of PR characteristics;

FIGS. 3A and 3B are illustrations showing typical factors (error factors) causing defects in a disk;

FIG. 4 is an illustration showing the relationship between the timing of binary data and the timing of equalized signals, which form the basis for evaluating errors;

FIG. 5 is an illustration showing examples of methods for calculating errors and creating histograms;

FIG. 6 is a flowchart showing the process flow of calculating errors and creating histograms;

FIG. 7 is a first illustration showing the results of actually obtaining error histograms of a real disk for all of twenty-six types of bit pattern; and

FIG. 8 is a second illustration showing the results of actually obtaining error histograms of a real disk for all of twenty-six types of bit pattern.

### DETAILED DESCRIPTION

A disk evaluating device and a disk evaluating method according to the present invention will now be described with reference to the attached drawings.

(1) Structure of Disk Evaluating Device

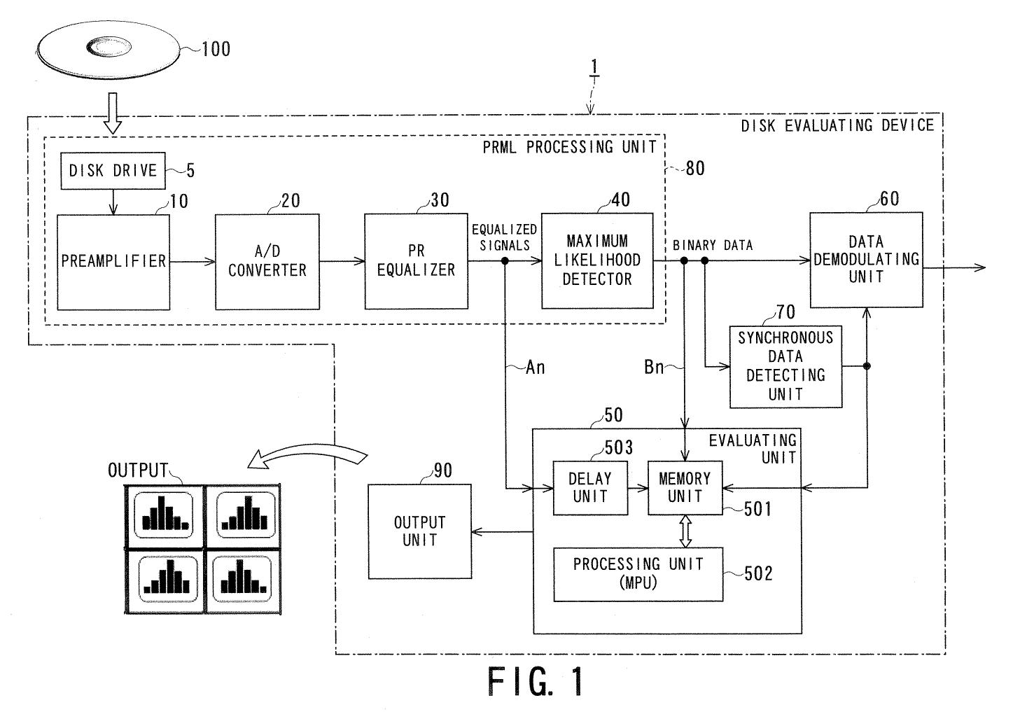

FIG. 1 is an illustration showing a typical structure of a disk evaluating device 1 according to an embodiment of the present invention.

The disk evaluating device 1 includes an evaluating unit 50 and a PRML processing unit 80. The PRML processing unit 80 reproduces signals recorded on a disk 100 to be evaluated and outputs binary data Bn. The evaluating unit 50 receives as the input the binary data Bn and equalized signals An that are intermediate processed signals of the PRML processing unit 80 and calculates evaluation data, for example, a histogram.

The disk evaluating device 1 may further include a data demodulating unit 60, a synchronous data detecting unit 70, and an output unit 90. The data demodulating unit 60 demodulates the binary data Bn. The synchronous data detecting unit 70 detects predetermined patterns contained in the binary data Bn to cause the data demodulating unit 60 to operate. The output unit 90 displays or prints evaluation data output from the evaluating unit 50.

The PRML processing unit 80 includes a disk drive 5, a preamplifier 10, an A/D converter 20, a PR equalizer 30, and a maximum likelihood detector 40. The disk drive 5 drives the disk 100 and reproduces signals recorded on the disk 100. The preamplifier 10 amplifies weak reproduced signals output from the disk drive 5. The A/D converter 20 converts the amplified reproduced signals to digital signals. The PR equalizer 30 equalizes the waveform of the digitized reproduced signals so that the digitized reproduced signals have a predetermined partial response waveform. The maximum likelihood detector 40 performs maximum likelihood decoding on the reproduced signals (hereinafter, called equalized signals An) on which waveform equalization has been performed by the Viterbi algorithm to output the binary data Bn.

The evaluating unit 50 includes a memory unit 501, a processing unit 502, and a delay unit 503. The delay unit 503 matches the timing of the equalized signals An to the timing of the binary data Bn. The memory unit 501 stores the equalized signals An and the binary data Bn. The processing unit 502 obtains a histogram and the like from the equalized signals An and the binary data Bn.

Ordinary disk playback devices include the data demodulating unit 60, the synchronous data detecting unit 70, and the PRML processing unit 80 among the foregoing components. It is assumed that these three components included in the disk evaluating device 1 are similar to those included in ordinary disk playback devices. Although the operations of these components are basically the same as those in known arts, the outline will now be described.

(2) Operation of PRML Processing Unit

In the following description, it is assumed that the disk 100 is an HD DVD medium.

The disk drive 5 includes a rotating drive mechanism for the disk 100 and an optical pickup and outputs data recorded on the disk 100 as weak reproduced signals (RF signals).

The preamplifier 10 is a low-noise amplifier that amplifies the weak reproduced signals to a predetermined level. The preamplifier 10 may include a low-pass filter and a high-pass filter. The reproduced signals converted to digital signals by the A/D converter 20 are input to the PR equalizer 30.

The PR equalizer 30 is a filter that equalizes the waveform of the reproduced signals so that the reproduced signals have predetermined PR characteristics. In general, the PR equalizer 30 includes an adaptive transversal filter.

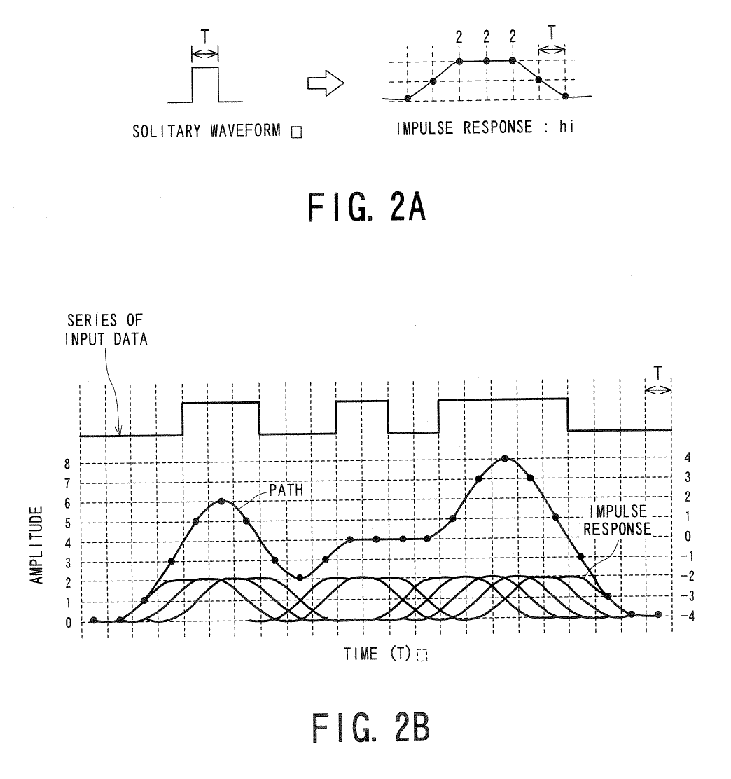

FIGS. 2A and 2B are illustrations showing the concept of PR characteristics. The type (class) of PR characteristics varies with the type (recording density) of a corresponding disk. For example, in HD DVD, PR characteristics of a class called PR(1,2,2,2,1) characteristic are adopted. FIG. 2A is an illustration showing impulse response characteristics corresponding to the PR(1,2,2,2,1) characteristic.

When a solitary wave (impulse) is input to a system that has the PR(1,2,2,2,1) characteristic, the impulse response waveform exhibits amplitude responses expressed by (1,2,2,2,1). Even when a solitary wave is input, the response waveform exhibits responses across five pulses, as shown in FIG. 2A. As the result, in a system that has PR characteristics, when a series of (pulse) waves is input, intersymbol interference occurs between adjacent five pulses in the output.

In compensation for allowing intersymbol interference, a system that has a band that is narrow compared with the band of a Nyquist system in which intersymbol interference does not occur can be implemented by a system that has PR characteristics. Thus, in a system that has PR characteristics, noise can be reduced even when a high-density disk is played back.

FIG. 2B shows an example of the equalized signals An that are ideal when data that contains a series of pulses is input.

The upper part of FIG. 2B shows input data to the system, which has the PR(1,2,2,2,1) characteristic. Specifically, the input data corresponds to data written to the disk 100.

The middle part of FIG. 2B shows the series of the equalized signals An corresponding to the input data. The lower part of FIG. 2B shows impulse responses corresponding to individual solitary waves (single pulses) to which the input data is broken down. These impulse responses have the same waveform as in FIG. 2A.

When a series of pulses (long pulse) is input, the amplitudes of impulse responses corresponding to adjacent single pulses that constitute the signals overlap each other. As the result, the equalized signals An shown in the middle part of FIG. 2B can be obtained.

In the case of the PR(1,2,2,2,1) characteristic, the pulse train in the equalized signals An is subjected to interference for a range across five pulses, and the impulse characteristics are expressed by (1,2,2,2,1). Thus, the maximum amplitude of the equalized signals An is eight. That is to say, when five pulses having a value of one continue, the maximum amplitude of eight is achieved. Even when more than five pulses having a value of one continue, the sixth and subsequent signals do not interfere with the equalized signals An. Thus, the maximum amplitude is eight for signals in all possible states.

On the other hand, the impulse characteristics are expressed by (1,2,2,2,1), the overlapping signals take on integer values. Thus, the equalized signals An take on only any one of nine integer values ranging from zero to eight. Even when replacement is performed so that the median is zero, there is no substantial difference. In this case, the equalized signals An take on any one of nine integer values ranging from minus four to plus four, as shown on the right ordinate of FIG. 2B.

In FIG. 2B, the positions on the time axis are set up so that each single pulse is located at the middle of impulse responses, for the sake of illustration.

The equalized signals An are input to the maximum likelihood detector 40, in which the series of the input data is decoded to be output as the binary data Bn. The maximum likelihood detector 40 obtains the binary data Bn using the Viterbi algorithm, which is generally used.

The Viterbi algorithm is publicly known and not related directly to the present invention. Thus, the description is omitted here.

The binary data Bn output from the maximum likelihood detector 40 is input to the data demodulating unit 60 in the following stage.

In HD DVD, the ETM (Eight to Twelve Modulation) code in which the minimum run length is one is recorded on the disk 100. The data demodulating unit 60 demodulates the ETM code into data that can be used by users.

(3) Operation of Evaluating Unit

FIG. 2B shows the waveform of the equalized signals An that are ideal, as described above. In this case, the amplitudes of sampling points (positions indicated by bullets) take on only any one of nine values at equal intervals. That is to say, the amplitudes never take on the intermediate values other than these nine values. Moreover, these nine values are uniquely determined by bit patterns of five pulses that are subjected to interference. Thus, for a specific bit pattern, for example, a bit pattern of 11111, the amplitude always takes on the maximum value of eight (in the case of the right ordinate, four). When the measurement value of the equalized signals An corresponding to the bit pattern of 11111 is not eight (in the case of the right ordinate, four), some error factors (for example, defects) are supposed to have occurred in the disk 100 or the recording and playback system.

When the disk evaluating device 1 is constructed as an evaluating device for the disk 100, sufficient time can be spent to adjust or calibrate a playback subsystem (mainly the PRML processing unit 80) or a recording subsystem that writes data to the disk 100 included in the disk evaluating device 1. Thus, these subsystems can be kept in almost ideal conditions. In this case, errors that occur in the equalized signals An are largely caused by factors arising from the disk 100. Factors causing defects in the disk 100 can be determined or narrowed down by evaluating the type and amount of each error.

In the present embodiment, bit patterns are extracted from the binary data Bn, and the difference between a standard value (ideal value) that is uniquely determined for each bit pattern and the corresponding one of the equalized signals An is obtained as an error, as described below. That is to say, the standard values (ideal values) for calculating errors are clearly defined.

When the quality of signals is low due to the low S/N ratio, errors may be distributed around the corresponding ideal values in a wide range. In this case, the ranges of errors corresponding to two adjacent ideal values may overlap each other and thus may not be distinguishable from each other. In the present embodiment, an error is separately calculated for each bit pattern. Thus, even when the quality of signals is low due to the low S/N ratio, the overlap between the ranges of errors corresponding to adjacent ideal values can be completely eliminated. Accordingly, a highly accurate error analysis can be performed.

In contrast, in known evaluating methods (for example, the methods disclosed in JP-A 2003-203429 and JP-A 2003-187534), the amplitudes, difference metrics, and the like of the equalized signals An are evaluated at the macro level for input in which unspecified bit patterns are mixed. Thus, the standard values (ideal values) may not be determined or may not be clear. Accordingly, the known evaluating methods are not suitable for correctly evaluating errors.

Moreover, a plurality of mixed bit patterns are input. Thus, when the quality of signals is low due to the low S/N ratio, the ranges of errors corresponding to adjacent ideal values overlap each other. Thus, errors cannot be analyzed with a high accuracy.

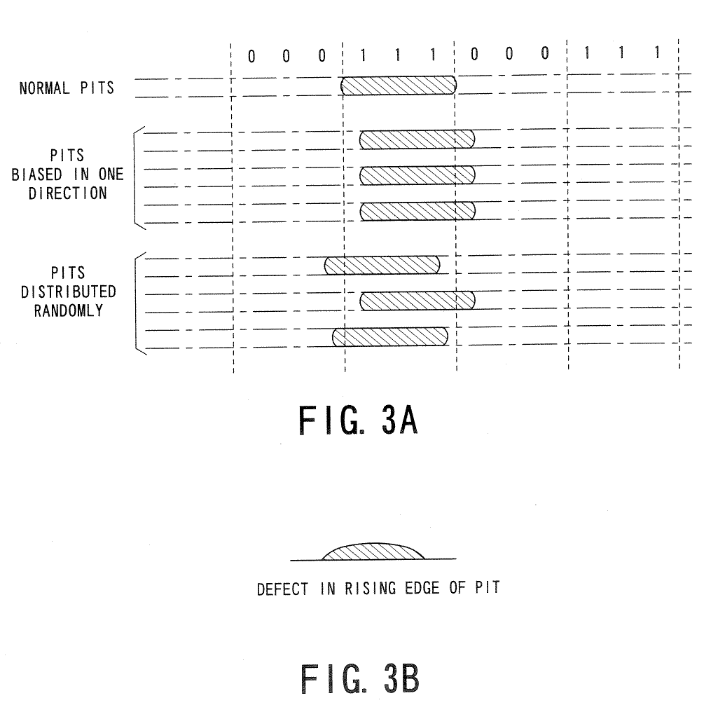

FIGS. 3A and 3B show typical factors (error factors) causing defects in the disk 100. For example, due to certain factors in manufacturing the disk 100, the positions of pits on tracks corresponding to a specific bit pattern of 111, deviated from the normal state in one direction, may be formed, or the positions of pits may vary randomly from the normal state, as shown in FIG. 3A. In these cases, biased errors or random errors with respect to ideal values occur in the equalized signals An played back from the disk 100.

Moreover, when the rising and falling edges of a pit are not clear, as shown in FIG. 3B, the pit cannot be clearly distinguished from the adjacent areas. This may cause errors in the equalized signals An.

It is necessary that the standard values (ideal values) that are the criteria for determining errors are clear to narrow down and analyze complicated error factors in the disk 100. To this end, it is extremely important that, in a state in which bit patterns are classified, not a state in which unspecified bit patterns are mixed, correct errors are obtained on the basis of the equalized signals An and standard values (ideal values) that are determined for the individual bit patterns.

The method in the present embodiment for classifying bit patterns, calculating errors for the individual classified bit patterns, and evaluating the errors (statistical processing) will now be described.

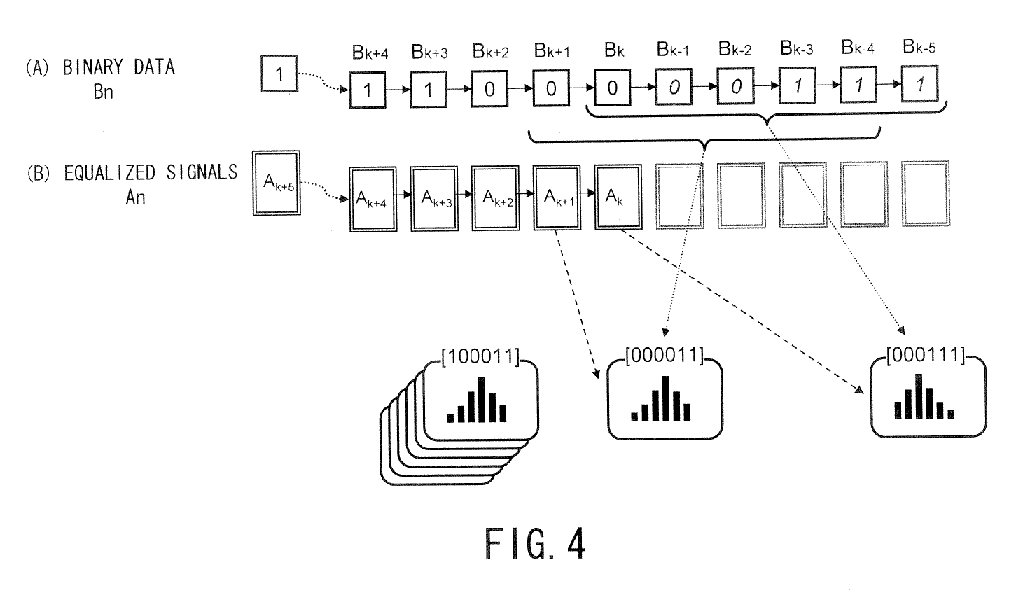

FIG. 4 is an illustration showing the relationship between the timing of the binary data Bn and the timing of the equalized signals An, which form the basis for evaluating errors.

The binary data Bn in FIG. 4 is output from the maximum likelihood detector 40 shown in FIG. 1. The subscripts indicate time. The equalized signals An are signals that are obtained by adjusting the timing of output signals from the PR equalizer 30 with the delay unit 503 in the evaluating unit 50. The subscripts indicate time in the same manner.

In general, in a system that has PR characteristics, the ideal value for the current value of the output (the equalized signals An) of the system is determined by a series of past N bits of input data. To be exact, past N bits include the current bit. However, this term is hereinafter described merely as past N bits. For example, in a system that has the PR(1,2,2,2,1) characteristic, the ideal value is determined by past five bits of input data. Since the binary data Bn output from the maximum likelihood detector 40 is decoded from a series of input data, the ideal value for the current value of the equalized signals An is determined by the values of past five bits of the binary data Bn. That is to say, the ideal value of an equalized signal Aₖ at time k is determined by Bₖ Bₖ₋₁, Bₖ₋₂, Bₖ₋₃, and Bₖ₋₄. In the example shown in FIG. 4, the ideal value of the equalized signal Aₖ is uniquely determined by corresponding past five bits, i.e., 00011. Similarly, the ideal value of an equalized signal Aₖ₊₁ is uniquely determined by corresponding past five bits, i.e., 00001.

Accordingly, correct statistics values of errors can be obtained by determining and classifying bit patterns of past five bits of the binary data Bn, which is sequentially input, and accumulating for each bit pattern the difference, i.e., an error, between the ideal value of each of the classified bit patterns and the value of the corresponding one of the equalized signals An.

In the present embodiment shown in FIG. 4, one bit is added to past five bits, and bit patterns of past six bits are determined and classified. In ideal conditions, an ideal value is determined only by the corresponding bit pattern of past five bits and is not affected by the additional sixth bit. That is to say, in ideal conditions, the ideal value corresponding to the bit pattern of past five bits must be the same as the ideal value corresponding to the bit pattern of past six bits.

However, in some conditions of pits formed on the disk 100, adjacent pits may interfere with each other. Thus, in the present embodiment, bit patterns of past N+1 (6) bits, not past N (5) bits, are determined and classified, and evaluation can be performed in consideration of the influence of the adjacent bits.

Specifically, the binary data Bn is classified as the bit pattern of six bits Bₖ, Bₖ₋₁, Bₖ₋₂, Bₖ₋₃, Bₖ₋₄, and Bₖ₋₅. Then, the error of the equalized signal Aₖ at time k is calculated on the basis of the ideal value of this bit pattern. In the example shown in FIG. 4, the error of the equalized signal Aₖ is calculated from the ideal value corresponding to a bit pattern of 000111, and the error of the equalized signal Aₖ₊₁ is calculated from the ideal value corresponding to a bit pattern of 000011.

The range of interference between bits may further expand, depending on types of error factor in the disk 100. In this case, a bit string to be determined and classified may include past N+2 or more bits.

The length of a bit string that is used to classify bit patterns is at least N-bit length. This is because the equalized signals An are determined by the conditions of past N bits, and thus, when bit patterns are classified using a bit length of N−1 or less bits, more than one ideal value exist, and the standard value for calculating an error cannot be uniquely determined.

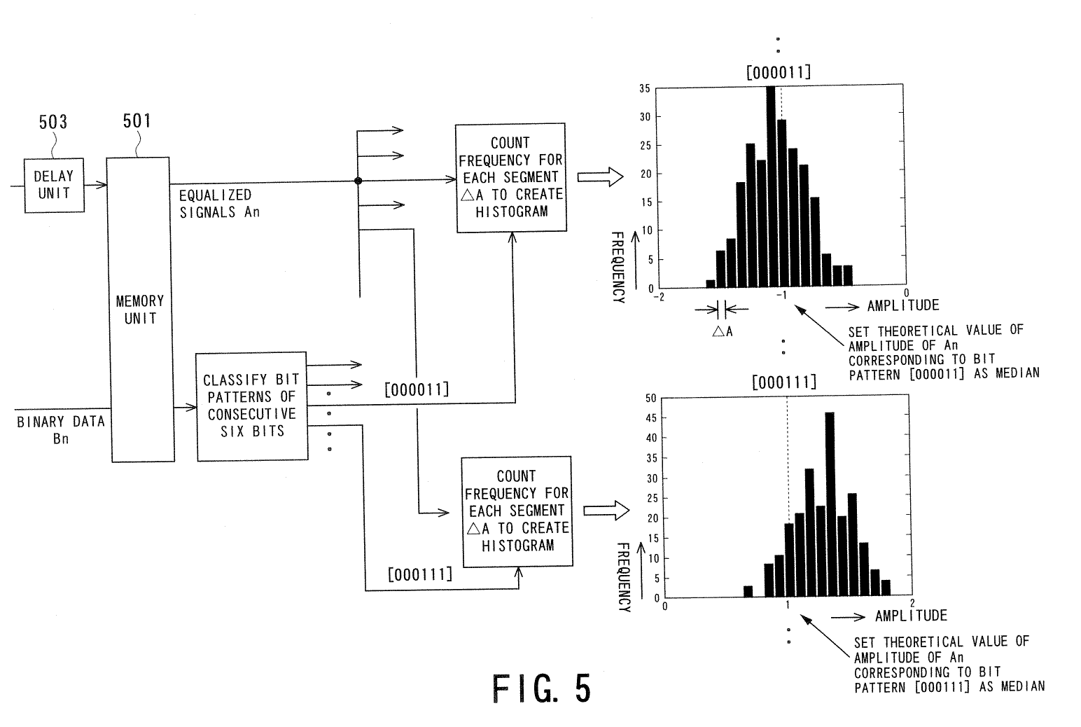

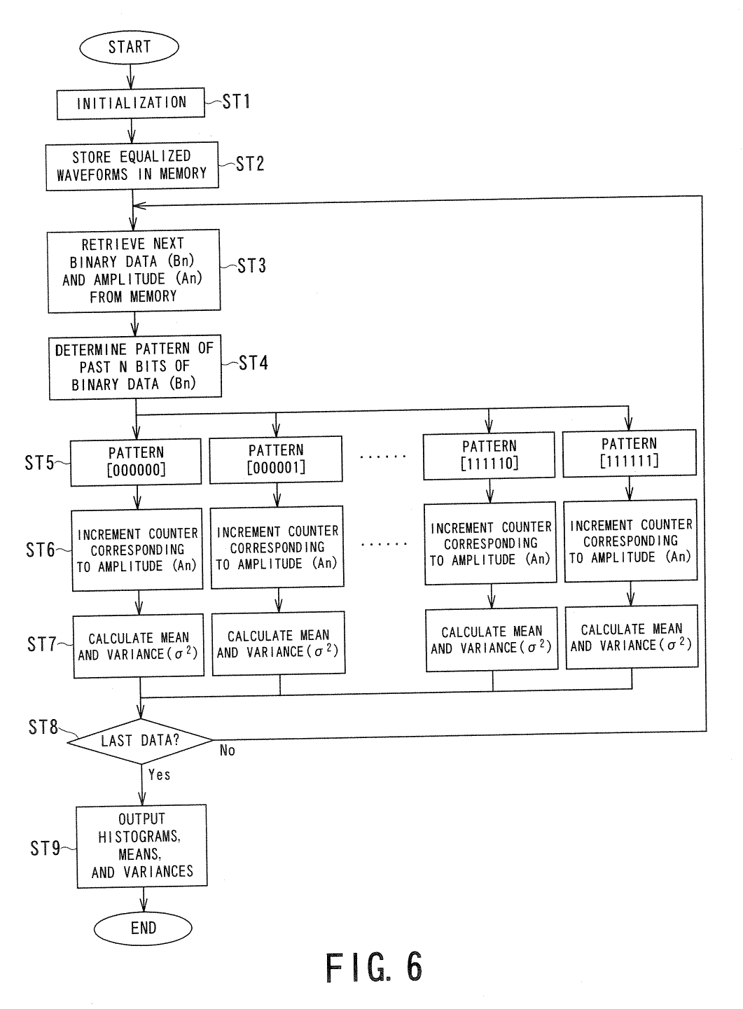

FIG. 5 is an illustration showing examples of methods for calculating errors and creating histograms. FIG. 6 is a flowchart showing the process flow of calculating errors and creating histograms. The method for evaluating the equalized signals An will now be specifically described with reference to these drawings.

In step ST1, the memory unit 501, the processing unit 502, and the like in the evaluating unit 50 are first initialized. Then, in step ST2, the binary data Bn output from the PRML processing unit 80 is stored in the memory unit 501 in the evaluating unit 50, and signals output from the PR equalizer 30 are also stored in the memory unit 501 after timing matching is performed on the signals by the delay unit 503.

The binary data Bn and the equalized signals An stored in the memory unit 501 are subjected to data processing in the processing unit (MPU) 502 in the evaluating unit 50.

In step ST3, the equalized signal Aₖ and the corresponding past six bits Bₖ, Bₖ₋₁, Bₖ₋₂, Bₖ₋₃, Bₖ₋₄, and Bₖ₋₅ of binary data are retrieved from the memory unit 501. Then, in steps ST4 and ST5, the bit pattern of the retrieved past six bits is determined and classified.

There should be sixty-four (2⁶) types of bit pattern for six bits. However, in HD DVD, since modulation is performed so that the minimum run length is one, states in which a single one or zero is isolated, for example, . . . 00100 . . . or . . . 11011 . . ., are eliminated. Thus, in practice, twenty-six types of bit pattern exist.

Then, in step ST6, a counter corresponding to the amplitude of the equalized signal Aₖ is incremented for each bit pattern. More specifically, an error is calculated from the amplitude of the equalized signal Aₖ and the standard value (ideal value) that is determined for each bit pattern, and the frequency of errors for the corresponding segment ΔA is incremented.

In step ST8, it is determined whether the last piece of a predetermined amount of data has been processed. The foregoing process is repeated at each point in time until the last piece of a predetermined amount of data has been processed. Finally, histograms can be obtained for individual bit patterns, as shown in FIG. 5. In the present embodiment, twenty-six histograms corresponding to the twenty-six types of bit pattern can be obtained.

In step ST7, instead of histograms, statistics values, such as the average value, variance, or standard deviation of errors that are calculated at individual points in time, may be calculated.

Needless to say, histograms in combination with statistics values, such as an average value, a variance, or a standard deviation, may be output.

In step ST9, the obtained histograms and statistics values are output to the output unit 90, which includes a display unit and a printer. While errors can be quantitatively evaluated by means of statistics values, such as the average value, variance, and the like of the errors, the types, amount, and the like of the errors can be visually grasped by means of histograms of the errors.

For example, an example of an error histogram of a bit pattern of 000011 is shown in the upper right part of FIG. 5. It is apparent from this histogram that errors are distributed almost symmetrically with respect to the standard value (minus one). That is to say, there are a few biased errors, and the histogram represents relatively normal status.

On the other hand, in an error histogram (shown in the lower right part of FIG. 5) of a bit pattern of 000111, the distribution of errors is biased upward from the standard value (one). In this case, there are many biased errors, and the quality of the disk 100 may have deteriorated due to certain factors. In this case, the quality of the whole signals can be improved by adjusting the recording conditions of the disk 100.

Moreover, the quality can be checked for each bit pattern by setting appropriate threshold values (not shown) on both sides of the standard value. For example, when errors fall within the range between the threshold values, it is determined that the quality is satisfactory, and when errors extend beyond the range between the threshold values, it is determined that the quality is unsatisfactory. Moreover, the quality of the disk 100 can be comprehensively checked by compiling the results of checking the quality for individual bit patterns.

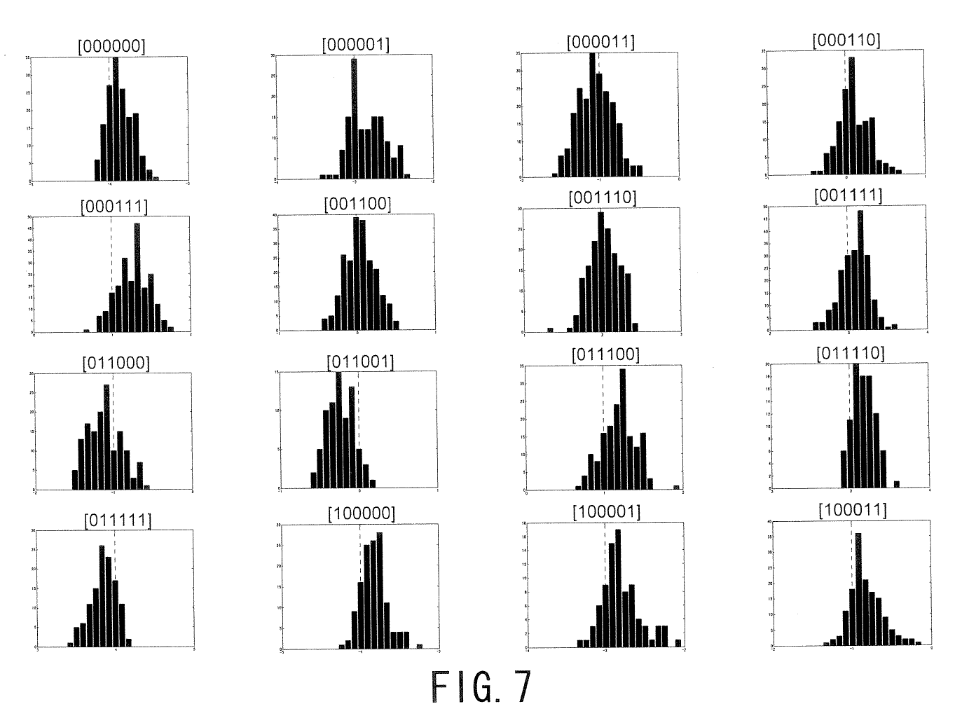

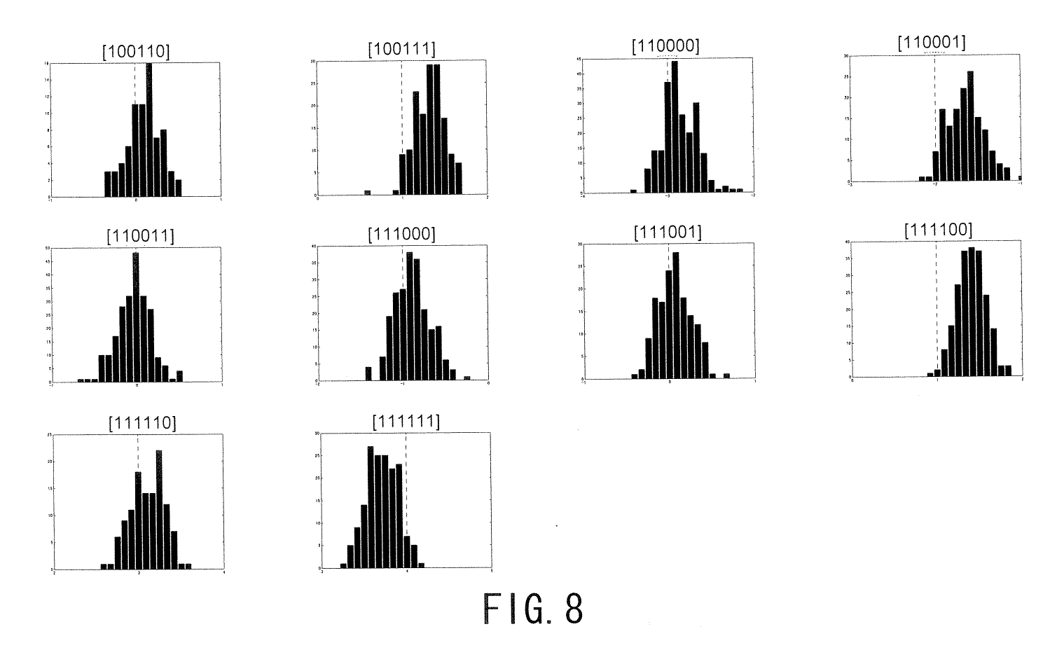

FIGS. 7 and 8 show the results of actually obtaining error histograms of a real disk for all of the twenty-six types of bit pattern using the foregoing evaluating method.

In these drawings, for example, in histograms for bit patterns of 000111, 011001, and 111100, the median of each error distribution deviates from each standard value. Thus, it can be presumed that this deteriorates the quality of the whole signals. Consequently, the quality of the whole signals can be improved by investigating and adjusting, for example, the recording conditions for these bit patterns.

In the disk evaluating device and the disk evaluating method according to the present embodiment, reproduced signals can be classified according to bit patterns, and errors can be calculated from the standard value (ideal value) that is uniquely determined for each bit pattern. Thus, the accuracy in evaluating errors can be improved. Moreover, the evaluation can be performed by means of simple components that include a memory unit and a processing unit (MPU).

The present invention is not limited to the foregoing embodiment. In the implementation phase, the present invention can be embodied with the components being modified without departing from the gist. Moreover, various types of invention can be made by means of appropriate combinations of the plurality of components disclosed in the forgoing embodiment. For example, some of the components disclosed in the embodiment may be eliminated. Moreover, components across different embodiments may be appropriately combined.

What is claimed is:

1. A disk evaluating device comprising:
a PR equalizer that equalizes reproduced signals from a disk to a response waveform of a partial response of a predetermined class;
a maximum likelihood detector that performs maximum likelihood decoding on output signals from the PR equalizer; and
an evaluating unit that classifies binary data output from the maximum likelihood detector into bit patterns of strings of consecutive bits, each of the strings having a predetermined length, and obtains a histogram of amplitudes of the output signals from the PR equalizer for each of the bit patterns.

2. The disk evaluating device according to claim 1, wherein the class of the partial response is determined by past N bits of binary data, and each of the strings of consecutive bits has a length of N or more bits.

3. A disk evaluating device comprising:
a PR equalizer that equalizes reproduced signals from a disk to a response waveform of a partial response of a predetermined class;
a maximum likelihood detector that performs maximum likelihood decoding on output signals from the PR equalizer; and
an evaluating unit that classifies binary data output from the maximum likelihood detector into bit patterns of strings of consecutive bits, each of the strings having a predetermined length, and obtains statistics values that include at least one of an average value, a variance, and a standard deviation of amplitudes of the output signals from the PR equalizer for each of the bit patterns.

4. A disk evaluating method comprising:
a PR equalizing step of equalizing reproduced signals from a disk to a response waveform of a partial response of a predetermined class;
a maximum likelihood decoding step of performing maximum likelihood decoding on output signals from the PR equalizing step; and
an evaluating step of classifying binary data obtained in the maximum likelihood decoding step into bit patterns of strings of consecutive bits, each of the strings having a predetermined length, and obtaining a histogram of amplitudes of the signals equalized in the PR equalizing step for each of the bit patterns.

5. The method according to claim 4, wherein the class of the partial response is determined by past N bits of binary data, and each of the strings of consecutive bits has a length of N or more bits.

6. A disk evaluating method comprising:
a PR equalizing step of equalizing reproduced signals from a disk to a response waveform of a partial response of a predetermined class;
a maximum likelihood decoding step of performing maximum likelihood decoding on output signals from the PR equalizing step; and
an evaluating step of classifying binary data obtained in the maximum likelihood decoding step into bit patterns of strings of consecutive bits, each of the strings having a predetermined length, and obtains statistics values that include at least one of an average value, a variance, and a standard deviation of amplitudes of the signals equalized in the PR equalizing step for each of the bit patterns.
